(19) United States
(12) Patent Application Publication
(10) Pub. No.: US 2015/0347364 A1
(43) Pub. Date: Dec. 3, 2015

(54) HIGHLIGHTING INPUT AREA BASED ON USER INPUT

(71) Applicant: Lenovo (Singapore) Pte. Ltd., New Tech Park (SG)

(72) Inventors: Jianbang Zhang, Raleigh, NC (US); John Weldon Nicholson, Cary, NC (US); Scott Edwards Kelso, Cary, NC (US); Steven Richard Perrin, Raleigh, NC (US)

(73) Assignee: Lenovo (Singapore) Pte. Ltd., New Tech Park (SG)

(21) Appl. No.: 14/294,560

(22) Filed: Jun. 3, 2014

(51) Int. Cl. G06F 17/24; G06F 3/0484; G06F 3/0481; G06F 3/0488

(52) U.S. Cl. CPC G06F 17/24; G06F 3/0488; G06F 3/04842; G06F 3/0481

(57) ABSTRACT

In one aspect, a device includes a touch-enabled display, a processor, and a memory accessible to the processor. The memory bears instructions executable by the processor to present at least a first input area at a first location on the touch-enabled display and receive first input to the touch-enabled display. The instructions are also executable to determine whether at least the first input is to be represented at the first input area, and highlight the first input area at least in part in response to a determination that at least the first input is to be represented at the first input area.

### I. FIELD

The present application relates generally to highlighting an input area on a display based on user input.

### II. BACKGROUND

There are currently no adequate and/or cost-effective solutions for providing first input to an input field presented on a device without having to first provide still other input to cause a caret to be presented at the input field, much less are there adequate and/or cost-effective solutions for indicating prior to presentation of the first input that a particular input field is the one to which the first input will be directed.

### SUMMARY

Accordingly, in one aspect a device includes a touch-enabled display, a processor, and a memory accessible to the processor. The memory bears instructions executable by the processor to present at least a first input area at a first location on the touch-enabled display and receive first input to the touch-enabled display. The instructions are also executable to determine whether at least the first input is to be represented at the first input area, and highlight the first input area at least in part in response to a determination that at least the first input is to be represented at the first input area.

In another aspect, a method includes determining that a triggering event has occurred at a device, highlighting a text entry field presented on a display in response to the determination that the triggering event has occurred, receiving input to the display, and presenting the input at the text entry field automatically and without presenting a cursor at the text entry field.

In still another aspect, a computer readable storage medium that is not a carrier wave bears instructions executable by a processor to process input to a display at least to determine which of a first text entry area and a second text entry area presented on a user interface (UI) is the one at which the input is to be represented, where at least a portion of the input is provided to a location of the display other than those presenting either of the first text entry area and second text entry area, and where the UI is presented on the display. The instructions are also executable to indicate on the display which of the first text entry area and second text entry area is the one at which the input will be represented.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is a block diagram of a network of devices in accordance with present principles;

FIG. 3 is a flow chart showing an example algorithm in accordance with present principles; and

FIGS. 4-11 are illustrations of example user interfaces (UIs) in accordance with present principles.

### DETAILED DESCRIPTION

This disclosure relates generally to device-based information. With respect to any computer systems discussed herein, a system may include server and client components, connected over a network such that data may be exchanged between the client and server components. The client components may include one or more computing devices including televisions (e.g. smart TVs, Internet-enabled TVs), computers such as desktops, laptops and tablet computers, so-called convertible devices (e.g. having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or other browser program that can access web applications hosted by the Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by e.g. a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g. that may not be a carrier wave) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and twisted pair wires. Such connections may include wireless communication connections including infrared and radio.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

“A system having one or more of A, B, and C” (likewise “a system having one or more of A, B, or C” and “a system having one or more of A, B, C”) includes systems that have A alone, B alone, C alone, A and B together, A and C together, B and C together, and/or A, B, and C together, etc.

The term “circuit” or “circuitry” is used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

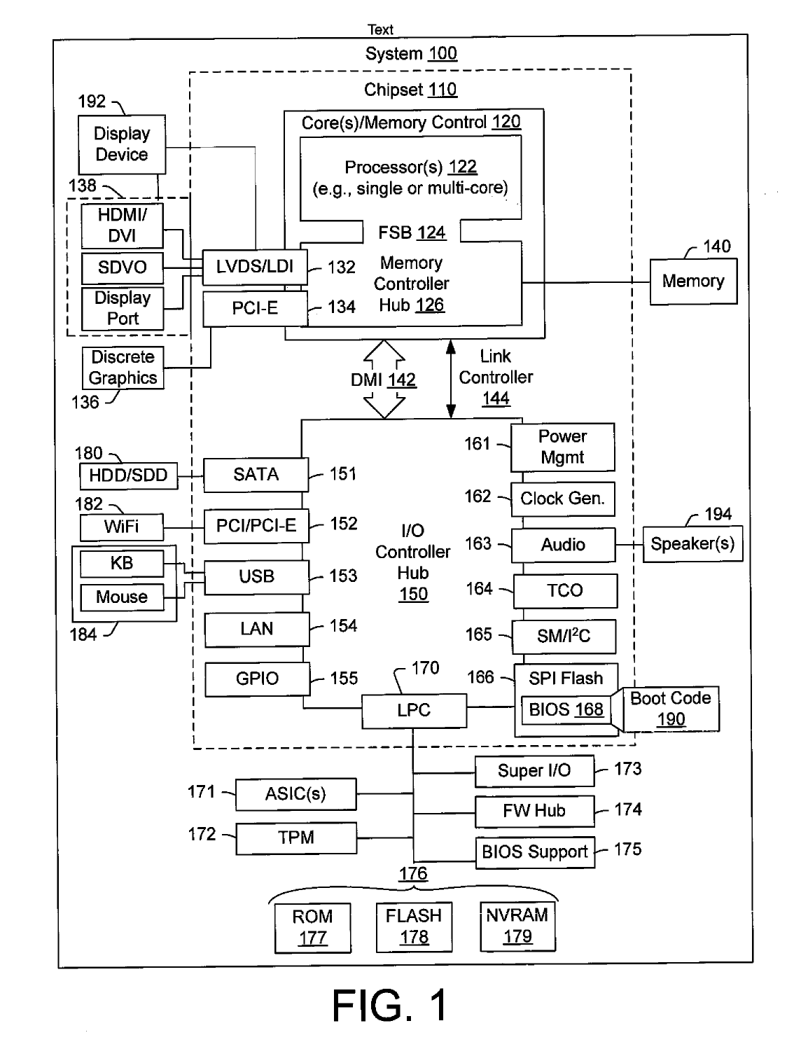

Now specifically in reference to FIG. 1, it shows an example block diagram of an information handling system and/or computer system 100. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be e.g. a game console such as XBOX® or Playstation®.

As shown in FIG. 1, the system 100 includes a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 further includes a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including e.g. one of more GPUs). An example system may include AGP or PCI-E for support of graphics.

The I/O hub controller 150 includes a variety of interfaces. The example of FIG. 1 includes a SATA interface 151, one or more PCL-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 provide for communication with various devices, networks, etc. For example, the SATA interface 151 provides for reading, writing or reading and writing information on one or more drives 180 such as HDDs, SDDs or a combination thereof, but in any case the drives 180 are understood to be e.g. tangible computer readable storage mediums that may not be carrier waves. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

In addition to the foregoing, the system 100 is understood to include an audio receiver/microphone 189 in communication with the processor 122 and providing input thereto based on e.g. a user providing audible input to the microphone 189. A camera 191 is also shown, which is in communication with and provides input to the processor 122. The camera 191 may be, e.g., a thermal imaging camera, a digital camera such as a webcam, and/or a camera integrated into the system 100 and controllable by the processor 122 to gather pictures/images and/or video. In addition, the system 100 may include a GPS transceiver 193 that is configured to e.g. receive geographic position information from at least one satellite and provide the information to the processor 122. However, it is to be understood that another suitable position receiver other than a GPS receiver may be used in accordance with present principles to e.g. determine the location of the system 100.

Additionally, though now shown for clarity, in some embodiments the system 100 may include a gyroscope for e.g. sensing and/or measuring the orientation of the system 100, and an accelerometer for e.g. sensing acceleration and/or movement of the system 100.

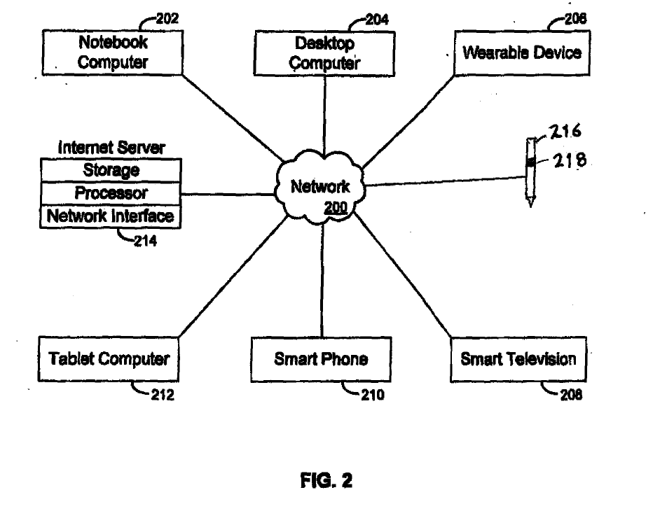

Before moving on to FIG. 2, it is to be understood that an example client device or other machine/computer may include fewer or more features than shown on the system 100 of FIG. 1. For instance, e.g., the system 100 may include one or more additional components to receive and/or provide input via different methods and/or of different types in accordance with present principles, such as e.g. the system 100 including or otherwise being associated with an active pen/stylus. Furthermore, note that e.g. for handwriting and/or drawing input to the system 100, the input may be provided remotely such as through Bluetooth signal and ultrasonic signal from another device (e.g. the pen). In any case, it is to be understood at least based on the foregoing that the system 100 is configured to undertake present principles.

Turning now to FIG. 2, it shows example devices communicating over a network 200 such as e.g. the Internet in accordance with present principles. It is to be understood that e.g. each of the devices described in reference to FIG. 2 may include at least some of the features, components, and/or elements of the system 100 described above. In any case, FIG. 2 shows a notebook computer 202, a desktop computer 204, a wearable device 206 such as e.g. a smart watch, a smart television (TV) 208, a smart phone 210, a tablet computer 212, an input device 216, and a server 214 in accordance with present principles such as e.g. an Internet server that may e.g. provide cloud storage accessible to the devices 202-212 and 216. It is to be understood that the devices 202-216 are configured to communicate with each other over the network 200 to undertake present principles.

Describing the input device 216 in more detail, it may be a pen such as e.g. an electronic pen and/or stylus pen. Furthermore, note that the device 216 is configured to provide input to one or more of the devices 202-214, including e.g. providing (e.g. handwriting) input to touch-enabled pads and touch-enabled displays on the devices 202-214 in accordance with present principles e.g. when in physical contact therewith and/or based on manipulation of the device 216 against another of the devices 202-214 by a user. Also note that the device 216 includes at least one selector element 218 which may be e.g. a button physically protruding from a housing of the device 216 and/or may be e.g. a touch-enabled selector element flush with the housing. In any case, the element 218 is understood to be selectable to provide input to the pen which may then be transmitted to another of the devices 202-214 in accordance with present principles.

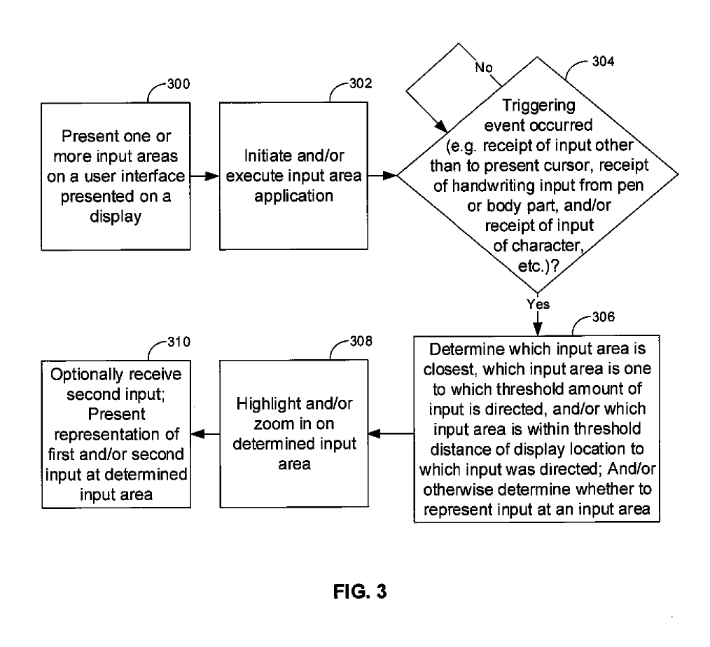

Now referring to FIG. 3, it shows example logic that may be undertaken by a device such as the system 100 in accordance with present principles. Beginning at block 300, the logic presents (e.g. on a user interface (UI)) one or more input areas (e.g. text entry fields) on a display of a device undertaking the present logic (referred to below as the “present device”) such as e.g. the system 100. The logic then proceeds to block 302 where the logic initiates and/or executes an application for undertaking present principles (e.g. if it has not already been initiated and/or executing, and/or in embodiments where the application itself did not at least in part cause the input areas to be presented but rather another application did so). In some embodiments, the application for undertaking present principles may be and/or include a transparent input method editor (IME) for e.g. processing and/or identifying handwriting input to the display and/or another input device such as e.g. a touch-enabled pad.

From block 302 the logic proceeds to decision diamond 304, at which the logic determines whether one or more triggering events has occurred. A negative determination causes the logic to continue making the determination at diamond 304 until an affirmative determination is made thereat. Once an affirmative determination is made, the logic proceeds to block 306, which will be described shortly. But first, note that in example embodiments, triggering events causing an affirmative determination to be made at diamond 304 may be one or more of the following: receipt of input other than to present a cursor (e.g. a caret) at one of the input areas being presented (e.g. a left to right drag of a pen tip on the display from a left area not including the input area across the input area to a right area not including the input area), receipt of (e.g. handwriting) input from a pen or body part of a person, receipt of input detected and/or determined to be input of one or more characters (e.g. alphabetical characters, numerical characters, and/or symbol characters), detection of a pen hovering over at least a portion of the display, detection of a body part of a person hovering over at least a portion of the display, detection of a pen contacting a portion of the display at a location not presenting an input area, detection of a body part of a user contacting a portion of the display at a location not presenting an input area, detection of a pen moving that has already been in contact with a portion of the display, detection of a body part of a person moving that has already been in contact with a portion of the display, detection of a pen rotating (e.g. a pen tip twisting in place) that has already been in contact with a portion of the display, detection of a body part of a person rotating (e.g. twisting in place) that has already been in contact with a portion of the display, receipt of a communication from a pen that a selector on the pen has been selected, and receipt of a gesture (e.g. in free space) from a user that input is being and/or will be directed to an input area. Thus, note that in some embodiments, the triggering event may not include input which is to be represented in accordance with present principles, while in other embodiments the triggering event may include input which is to be represented in accordance with present principles.

In any case, as indicated above once an affirmative determination is made at diamond 304, the logic proceeds to block 306. At block 306, the logic determines which input area is closest to the location of the display to which the triggering input was directed (and/or in instances where e.g. only one input area is being presented, determines that the input area is the only area and/or that input is to be represented thereon), which input area is within a threshold distance (e.g. as set by a user manipulating a settings UI such as the UI 1100 to be described below) of the location of the display to which the triggering input was directed, and/or whether an input area has had a threshold amount of the triggering input directed thereto even if e.g. some of the input was directed to locations of the display not presenting any input area and/or presenting one or more other input areas. Also at block 306, the logic may otherwise determine whether to represent input at a particular input area as set forth herein.

After block 306, the logic proceeds to block 308 where the logic highlights, zooms in on, and/or otherwise indicates the input area to which input is being or will be represented (e.g. still without presenting a caret at that input area). From block 308 the logic proceeds to block 310 where the logic may receive additional input (e.g. second input), but in any case presents a representation of the first and/or additional input at the determined (e.g. and now highlighted) input area.

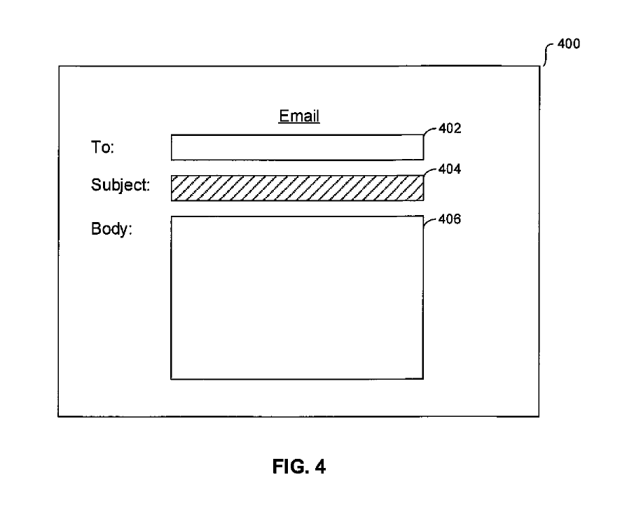

Continuing the detailed description in reference to FIG. 4, it shows an example user interface (UI) 400 presenting plural text entry fields. In the present example, the UI 400 is for composing an email and includes a first text entry field 402 for inputting at least one recipient for the email, a second text entry field 404 for inputting at least one subject for the email, and a third text entry field 406 for inputting text to form at least a portion of the body of the email. Note that the area 404 is highlighted in accordance with present principles (e.g. based on a determination that input being or to be received is to be represented thereat), as represented by the diagonal lines shown. Also note that in the example shown, the highlighting does not extend to other portions of the display beyond the portion presenting text entry field 404 itself.

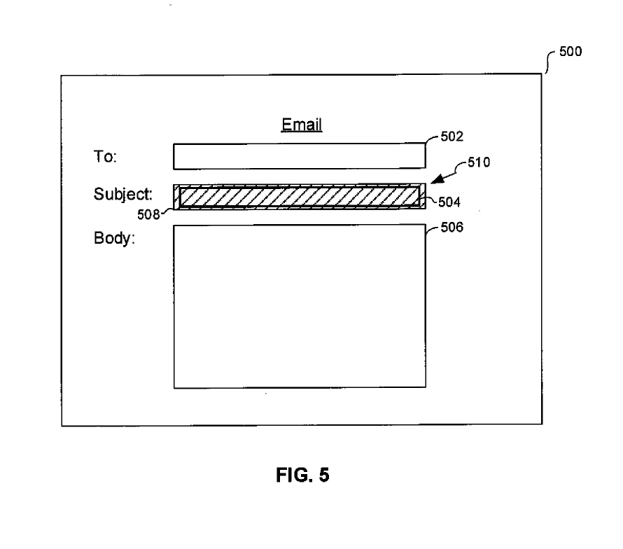

In contrast, FIG. 5 shows an example UI 500 similar to the UI 400 (e.g. with a recipient text entry field 502, subject text entry field 504, and body text entry field 506), but with highlighting (as represented by the diagonal lines shown) encompassing and/or establishing an area 508 including the text entry field 504 and at least a portion of the UI 500 surrounding and extending beyond the text entry field 504. Furthermore, in addition to the highlighting of the area 508, note that an indicator arrow 510 is also presented for indicating that the area 504 is the one at which the input being received and/or to be received will be represented in accordance with present principles.

With respect to the highlighting represented by the diagonal lines shown on both FIGS. 4 and 5, and indeed any of the highlighting described herein, it is to be understood that the highlighting may be e.g. a neon and/or bright color, but in any case in example embodiments is of a color different from the color at which the text entry field was presented prior to a determination leading to the text entry field being highlighted (e.g. a determination of whether at least some input is to be represented at the text entry field).

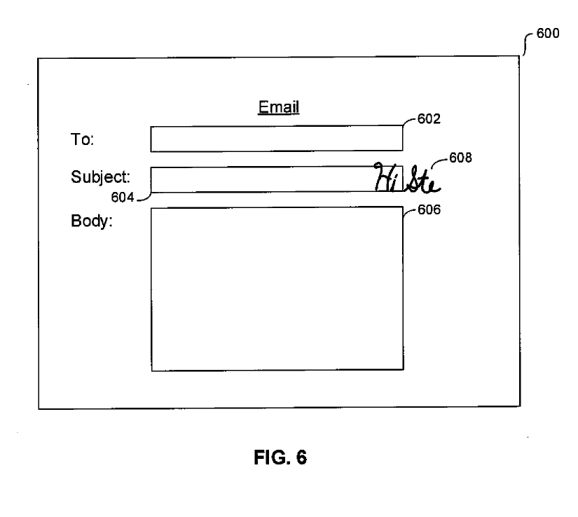

Continuing the detailed description in reference to FIG. 6, it shows an example UI 600 similar to e.g. the UI 400 (e.g. with a recipient text entry field 602, subject text entry field 604, and body text entry field 606). However, as may be appreciated from FIG. 6, handwriting input (e.g. from a pen and/or portion of a person's body) has been directed to the UI 600 as represented by the tracing 608. Note that some but not all of the input represented by the tracing 608 is directed to the area 604, and more specifically some of the input is directed to a portion of the UI 600 not presenting any text entry field. In cases such as the present one where at least a portion of the input is directed to a portion of the UI 600 not presenting a text entry field (and/or another portion of the display not presenting the UI 600, and/or another portion of the UI 600 presenting another text entry field), one or more determinations as disclosed herein may be made to determine which text entry field to highlight and/or which text entry field is the one to represent input thereat. E.g., taking FIG. 6 as an example, it may be determined whether a threshold amount of input (e.g. a threshold amount of area to which the input is directed, a threshold number of characters, a threshold number of words, a threshold number of sentences, etc.) from the input represented by the tracing 608 has been directed to the text entry field 604, and/or if no such threshold amount has been met, then other determinations as discussed herein (e.g. determinations regarding threshold distances, nearest areas to the location(s) where the input was provided, that there is only one text entry field presented) may be used to determine which text entry field should be highlighted and/or used to present a representation of the content.

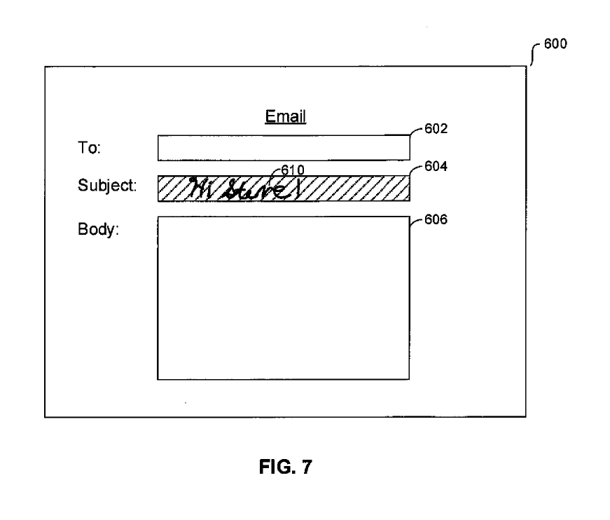

Thus, e.g. taking the example shown in FIG. 6, assume the threshold amount of input is two characters. The device presenting the UI 600 may e.g. based on using handwriting and/or character recognition principles and/or software, determine that two characters established by the cursive handwriting of the word “Hi” have had at least a threshold amount of each the characters for the letters “H” and “i” directed to the area 604. Based on that determination, the device may highlight the area 604 as shown in FIG. 7 (represented by the diagonal lines in the area 604) and/or include a representation 610 of the input represented by the tracing 608. Furthermore, note that while the input represented by the tracing 608 contained the characters “Hi Ste”, additional input was provided (e.g. after the area 604 was highlighted as shown in FIG. 7) including the characters “ve!”, and hence the representation 610 includes the (e.g. total and/or single line of) input provided by a user to the display presenting the UI 600 (e.g. “Hi Steve!”).

Furthermore, note that although FIG. 7 shows the representation 610 being scaled based on the actual input represented by the tracing 608 to thus fit within the area 604, in other embodiments the scale of the representation may be the same as the scale of the input and hence the representation of the input may be centered (e.g. as best as possible at the scale) at the text entry field 604 but with at least a portion of the representation overlapping and/or extending beyond the area 604.

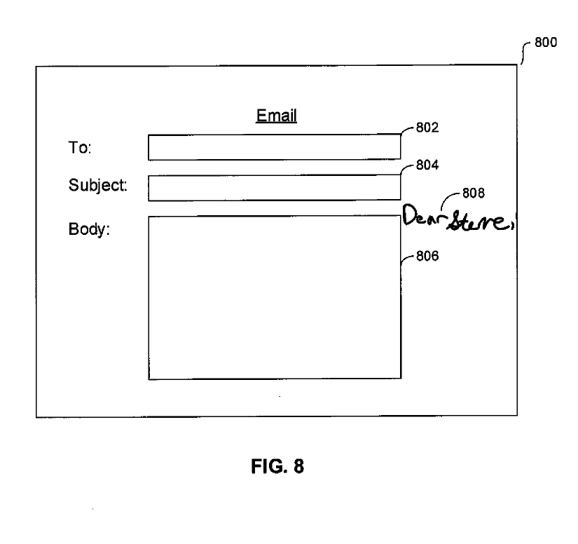

Continuing with reference to FIG. 8, it shows an example UI 800 similar to e.g. the UI 400 (e.g. with a recipient text entry field 802, subject text entry field 804, and body text entry field 806). In contrast to some of the other figures discussed herein, FIG. 8 shows that handwriting input (e.g. from a pen and/or portion of a person's body) has been directed to a portion of the UI 800 (as represented by the tracing 808) not presenting a text entry field. In such an instance, one or more of the determinations discussed herein may be made to determine which of the areas 802, 804, and 806 is the one to highlight to indicate that a representation of the input will be presented thereat, and/or the one at which the representation of the input will be presented. Furthermore, and also in such an instance, the device presenting the UI 800 may also make determinations of which text entry field to highlight and/or at which to present representations of the input based on the content of the input itself, such as e.g. whether the content contains an “@” symbol for the word “at” that is typically found in an email address, and hence determine that such input containing the “at” symbol should be entered into the area 802.

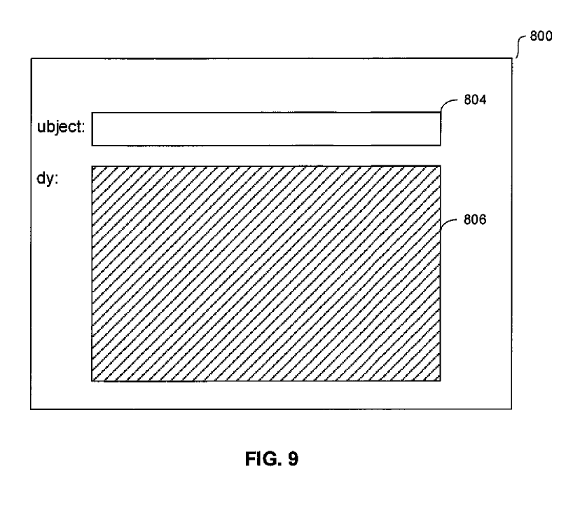

As another example based on what is shown in FIG. 8, “dear” (appearing before the word “Steve” as shown) may be recognized by the device as a salutation opening a body portion of the email and hence determine that the area 806 is the area to highlight based on “Dear Steve” being provided to the display presenting the UI 800. Continuing with this example, one or more determinations that the area to highlight is the area 806 based on the input being “Dear Steve” directed to an area of the UI 800 not including a text entry field may cause the area 806 to not only be highlighted but also in some embodiments may cause the device to automatically without further user input zoom in on the field 806, as shown in FIG. 9. Note that the area may be highlighted as shown (e.g. as represented by the diagonal lines), but also note that in some embodiments the area may be highlighted and a representation of the handwriting input “Dear Steve” may also be presented thereat. Even further, note that once input has ceased being provided (e.g. after a threshold time from the last received portion of input), in some embodiments the device may zoom back out on the UI to a default perspective and/or a zoom level at which the UI was presented prior to zooming in, such as e.g. again causing the UI 800 to appear as it is presented in FIG. 8.

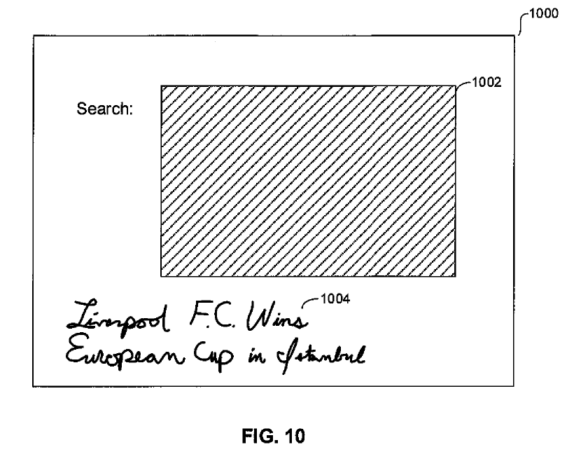

Now in reference to FIG. 10, it shows an example of a device presenting only one text entry field. Thus, the UI 1000 shown includes text entry field 1002 and no other entry fields. As shown, handwriting input (e.g. from a pen and/or portion of a person's body) that has been directed to the UI 1000 is represented by the tracing 1004. Note that the input as represented by the tracing 1004 has not been directed to the field 1002 but instead has been directed to another portion of the UI 1000 not presenting a text entry field. However, in other embodiments some or all of the input as represented by the tracing 1004 may be directed to the text entry field 1002. But in either case, the device presenting the UI 1000 may determine and/or identify that there is only one text entry field being presented, and hence determine that the text entry field 1002 is to be highlighted as shown.

Note that the input as represented by the tracing 1004 contains multiple words, but that no representations of the input are yet presented in the field 1002 as shown. While in some embodiments the input may be represented in the determined field in real time as the input is received and while the corresponding field is highlighted, in other embodiments the input may not be represented at the determined field e.g. until a threshold time has ben reached from receiving a portion of the input (e.g. the last word or portion of the input), e.g. until a threshold time has been reached from when a pen or body part ceases contacting the display to which the input is presented, etc. Note that in some embodiments those thresholds may be set by a user e.g. by manipulating a settings UI such as the UI 1100 described below.

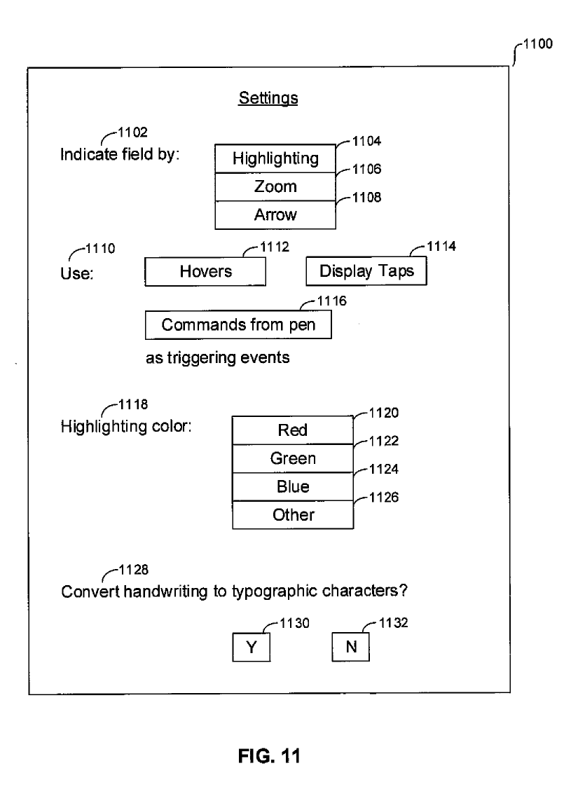

Continuing the detailed description in reference to FIG. 11, it shows an example settings UI 1100 for configuring settings of an application undertaking present principles. Thus, a first setting 1102 is shown for selecting one or more types of indications for text input fields at which input will be presented and/or represented in accordance with present principles. Accordingly, the first setting 1102 includes selector elements 1104, 1106, and 1108, all of which are understood to be selectable to automatically without further user input configure the application and/or device presenting the UI 1100 to present the associated respective indication. Thus, the selector element 1104 is selectable for highlighting such fields, selector element 1106 is selectable to zooming in on such fields, and a selector element 1108 is selectable for causing an arrow to be presented which points to such fields.

The UI 1100 also includes a second setting 1110 for configuring triggering events in accordance with present principles. Plural selector elements are shown for the setting 1110, all of which are understood to be selectable to automatically without further user input configure the device to use the triggering event associated with the respective selector element. Thus, a first selector element 1112 is shown for configuring the device to use hovers over a device of e.g. a pen and/or a body part as a triggering event, a second selector element 1114 is shown for configuring the device to use display contact and/or taps from e.g. a pen and/or a body part as a triggering event, and selector element 1116 is shown for configuring the device to use one or more commands transmitted by a pen as a triggering event. Regarding such commands from a pen, it is to be understood that a button such as the element 218 discussed above may be selected to communicate (e.g. via Bluetooth or NFC communication) a command to the device presenting the UT 1100 to cause the device to highlight a text entry field to which input will be directed should the pen then be used to provide input to the display of the device (e.g. and based on a detection by the device that the pen is hovering over a particular area nearest a particular text entry field when the button is selected).

Still in reference to FIG. 11, it includes a third setting 1118 including one or more selector elements for selecting one or more colors in which the device is to highlight areas and/or text input fields, all of which are understood to be selectable to automatically without further user input configure the device to highlight input areas in the color associated with the selected selector element. Thus, a selector element 1120 is shown for red highlighting, a selector element 1122 is shown for green highlighting, and a selector element 1134 is shown for blue highlighting. In addition to the foregoing, note that a selector element 1126 is shown and is selectable to e.g. highlight input areas in a customized and/or user-selected color. However, note that in other embodiments the element 1126 may be selectable to e.g. cause another UI to be presented on the device from which to select another color (e.g. other than red, green, or blue).

A fourth setting 1128 is shown in FIG. 11 as well. The setting 1128 pertains to whether to convert handwriting input to the device to typographic characters when presenting a representation of the input. Thus, a yes selector element 1130 is shown for selection to automatically without further user input configure the device to present representations as typographic characters, while a no selector element 1132 is shown for selection to automatically without further user input configure the device to present representations that trace and/or correspond to the input to the device (e.g. handwriting input will be represented as the handwriting itself).

Without reference to any particular figure, it is to be understood that first and second input as discussed herein may be e.g. two different portions of the same sequence of input, two different portions of a single stroke and/or character of input, different letters, different words, different sentences, etc.

Also without reference to any particular figure, it is to be understood that present principles (e.g. including an application for undertaking present principles) may be used in conjunction with other applications presenting text entry fields that are to be highlighted as discussed herein. In such instances, the application for highlighting may be presented as a so-called transparent layer on top of the other application presenting the text entry field to thus highlight and/or represent input at the text entry field. Notwithstanding, in some embodiments the highlight and/or representation features discussed herein may be embedded in the UI (e.g. and its text entry fields) e.g. by default.

Furthermore, it is to be understood that in addition to or in lieu of either or both of input directed to a display from a pen or body part of a user, a keyboard (e.g. physical keyboard or so-called soft (e.g. virtual) keyboard) may also be used to provide input without first causing a caret to be presented at any particular field, and hence responsive to input from a keyboard the device may make one or more of the determinations discussed herein to determine which text entry field (e.g. of one or more being presented) is the one to highlight in accordance with present principles. Further still, it is to be understood that input may be provided from still other types of input devices to highlight a text entry field as disclosed herein without the user first selecting a particular text entry field as the field at which input is to be represented, such as e.g. a touch-enabled pad (e.g. mouse pad as used on laptop computers).

Again without reference to any particular figure, it is to be understood that the highlighting and/or arrow indications discussed herein may be caused to blink by being presented and then disappearing repeatedly e.g. in predefined and equal lengths of time to further draw the user's attention to a text entry field at which a representation of the user's input will be presented. Still further, in some embodiments the highlighting may start at a point in the (e.g. both vertical and horizontal) middle of the text entry box and expand to encompass and even go beyond the full area of the text entry field itself, and even further in some embodiments may then contract back down to the point and repeat expansion so as to further draw the user's attention to a text entry field at which a representation of the user's input will be presented. Also in some embodiments, highlighting need not occupy and/or highlight the entire area of a text input field (e.g. at any point in time during a highlighting instance for that particular field) but e.g., if an email body area is a multiple line field, the highlighting may also be presented so as to only highlight one or couple lines or areas of the field at which the input will be represented rather than the entire area.

Discussing the determinations described above for determining the nearest text entry field to a portion of a UI to which e.g. handwriting input has been directed and/or for determining a nearest text entry field within a distance threshold, it is to be understood that such determinations may be made relative to a particular portion of each respective text entry field, such as e.g. the left-most boundary of each text entry field for input that is to be represented thereat left to right as the input is provided (or conversely, a right-most boundary for languages read and written right to left), an upper-left corner of the text entry field, or a middle of the text entry field.

Now discussing sequences of input provided to a display in accordance with present principles where e.g. two lines of input are determined and/or identified (e.g. the user handwrites what are identified as two lines of input owing to a first portion (e.g. a few words) of the input being directed (e.g. in a line or at least substantially in a line) to an area of the display above another portion of the display to which a second portion (e.g. other words) of the input is directed), whether to highlight and/or represent both lines of input in a single text entry field or whether to highlight and/or represent each line in separate text entry fields being presented may be determined and/or based on various circumstances. However, it is first to be noted that when only one text entry field is presented, both lines of input may be represented thereat and/or that field may be highlighted.

Regardless, such a determination regarding multiple lines of input when multiple fields are present may be e.g. that only a single field allows for representation of multiple lines of input and hence that field should be highlighted. Taking the email text entry fields discussed from above as an example, a subject text entry field may be for only a single line of input, whereas the body text entry field may be for plural lines of input, and therefore a determination upon receiving multiple lines of input may be made that the body text entry field should be highlighted and/or that the multiple lines should be represented at the body text entry field. However, also note that in circumstances where plural text entry fields allowing for representations of multiple lines of input are presented, a combination of the determinations discussed herein may be used to determine which text entry field to highlight, such as e.g. determining and/or identifying the text entry fields allowing for multiple lines and then determining which of those text entry fields is the nearest, and accordingly highlighting that field.

However, in instances where the device determines that the plural lines of input are to be represented at different fields e.g. based on their respective content as discussed above (e.g. a line with the “at” symbol may cause the recipient field to be highlighted whereas a line beginning with a salutation may cause the email body field to be highlighted), as each line of input is provided the corresponding text entry field at which the input will be represented may be highlighted.

Still further, to determine which of multiple lines of input is to go to which text entry field, keyboard events, pen events, other input device events, and gesture events may be tracked and/or monitored to determine whether any of those events represent a command to change fields that are highlighted and/or to which input is to be represented. Examples of such commands include an “enter” command provided from a keyboard, selection of the tab button from a keyboard, a “\n” command, or another equivalent “next field” command.

Again without reference to any particular figure, it is to be understood that when e.g. a text entry field is highlighted and a user determines that another field should instead be highlighted and/or that input he or she is or will be providing should be represented at another field, the user may enter a predefined command (e.g. select the tab button on a keyboard) to cause the highlighting to change in sequence (e.g. top to bottom, left to right) from one text entry field to the next based on user input.

It may now be appreciated that present principles provide for writing directly to any portion of a display even if not directly to a text entry field presented thereon, and having a highlighting indication of a text entry field at which the input will be presented. Thus, it is to be understood that in at least some of the embodiments discussed above, a transparent Input Method Editor (IME) can be employed so that users can write on top of existing text input fields, and/or near existing text input fields, and/or at least identify fields at which input will be represented based on those fields being highlighted (e.g. highlighting the field near and/or below a stylus pen detected as hovering over the field) so users e.g. can have a better knowledge about which field is currently active.

Thus, by using transparent IME, users may be provided with the freedom to write directly on any text input field (e.g. without first manipulating a cursor) and/or to have such fields highlighted (e.g. fields the user is already or is going to be writing on). The highlight effects discussed herein may be triggered by various methods such as a pen motion event (e.g. hover, pen button press, pen rotation, etc.), a pen touch event (e.g. pen down, pen move) and/or one or more gestures. For example, when hovering a pen over the display, the field that will be active when the pen touches the screen is highlighted, thus allowing the user to hover around the page or UI until the field they want to direct input to is highlighted. As another example, if hovering not over a field, the closest field may be highlighted as described herein, and/or only the closest field may be highlighted if within a distance threshold and otherwise no fields may be highlighted.

What's more, present principles recognize that the highlighted field may be determined based on being the closest field by some distance measure (e.g., the distance could be expressed and/or determined based on Euclidean space and/or geometry). In addition to or in lieu of the foregoing, the determinations of nearest fields and distance thresholds discussed herein may vary depending on the types of fields presented, applications used for which fields are presented, and/or types of input received. E.g., multi-line input provided to a relatively large white space of a window of an email application may cause the email body field to be highlighted based on e.g. that field being the only one at which multiple lines of input may be represented, whereas input to a display presenting plural webpage text entry fields on a webpage also including text and graphics may cause one of the fields to be highlighted based on being the nearest field and/or within a distance threshold as discussed herein (or even e.g. a different, relatively smaller threshold than for the email application (e.g. for web pages in particular)).

Discussing the highlighting described herein, it is to be understood that the highlight effect may include a glow effect and/or may be semitransparent color, etc. Furthermore, when zooming in in accordance with present principles, such an effect may, in addition to indicating an active text entry field to a user, also provide the user with more room to write (e.g. directly to the text entry field owing to that field now being presented on a relatively larger area of the display).

Before concluding, it is to be understood that although e.g. a software application for undertaking present principles may be vended with a device such as the system 100, present principles apply in instances where such an application is e.g. downloaded from a server to a device over a network such as the Internet. Furthermore, present principles apply in instances where e.g. such an application is included on a computer readable storage medium that is being vended and/or provided, where the computer readable storage medium is not a carrier wave.

While the particular HIGHLIGHTING INPUT AREA BASED ON USER INPUT is herein shown and described in detail, it is to be understood that the subject matter which is encompassed by the present application is limited only by the claims.

What is claimed is:

1. A device, comprising:
a touch-enabled display;
a processor;
a memory accessible to the processor and bearing instructions executable by the processor to:
present at least a first input area at a first location on the touch-enabled display;
receive first input to the touch-enabled display;
determine whether at least the first input is to be represented at the first input area; and
at least in part in response to a determination that at least the first input is to be represented at the first input area, highlight the first input area.

2. The device of claim 1, wherein the first input is input that is selected from the group consisting of: input other than to present a vertically-oriented cursor element at the first input area, and input for more than to present a vertically-oriented cursor element at the first input area.

3. The device of claim 1, wherein the instructions are further executable to present, at the first input area while the first input area is highlighted, a representation at least of the first input.

4. The device of claim 1, wherein the instructions are further executable to receive second input to the touch-enabled display and present a representation of at least the first input and the second input at the first input area.

5. The device of claim 4, wherein the instructions are further executable to present the representation while the first input area is highlighted.

6. The device of claim 1, wherein the first input area is a text entry field.

7. The device of claim 1, wherein the first input area is highlighted in a first color different from a second color at which the first input area is presented prior to the determination whether at least the first input is to be represented at the first input area.

8. The device of claim 4, wherein the first input comprises a first portion of handwriting input, and wherein the second input comprises a second portion of handwriting input.

9. The device of claim 8, wherein the instructions are executable by the processor to determine that the first input and second input pertain to handwriting input, and in response to the determination that the first and second input pertain to handwriting input, present the representation.

10. The device of claim 8, wherein the first and second portions of handwriting input are received at the touch-enabled display from an element sensed at the touch-enabled display and selected from the group consisting of a pen and a body part of a user.

11. The device of claim 1, wherein the instructions are executable by the processor to:
determine that the first input pertains to at least one character selected from the group consisting of an alphabetical character and a numerical character; and
at least in part based on the determination that the first input pertains to at least one character, determine that at least the first input is to be represented at the first input area.

12. The device of claim 1, wherein at least a portion of the first input is directed to a second location on the touch-enabled display not presenting the first input area.

13. The device of claim 12, wherein the instructions are executable to determine whether at least the first input is to be represented at the first input area based at least in part on a determination that a threshold amount of the first input is directed to the first location.

14. The device of claim 12, wherein the instructions are executable to determine whether at least the first input is to be represented at the first input area based at least in part on a determination that the first input area is at least one of the only input area presented on the touch-enabled display and the nearest input area to the second location presented on the touch-enabled display.

15. A method, comprising:
determining that a triggering event has occurred at a device;
in response to the determination that the triggering event has occurred, highlighting a text entry field presented on a display;
receiving input to the display; and
automatically and without presenting a cursor at the text entry field, presenting the input at the text entry field.

16. The method of claim 15, wherein the input is directed to an area of the display not presenting the text entry field.

17. The method of claim 16, wherein the input is presented at the text entry field without the device receiving user input that the input is to be presented in the text entry field.

18. The method of claim 15, wherein the triggering event is selected from the group consisting of: detection of a pen hovering over at least a portion of the display, detection of a body part of a user hovering over at least a portion of the display, detection of a pen contacting a portion of the display at a location not presenting the text entry field, detection of a body part of a user contacting a portion of the display at a location not presenting the text entry field, detection of a pen already in contact with a portion of the display moving, detection of a body part of a user already in contact with a portion of the display moving, and receipt of a communication from a pen that a selector on the pen has been selected.

19. The method of claim 15, comprising:
automatically and without presenting a cursor at the text entry field, presenting the input at the text entry field and zooming in on the text entry field.

20. A computer readable storage medium that is not a carrier wave, the computer readable storage medium bearing instructions executable by a processor to:
process input to a display at least to determine which of a first text entry area and a second text entry area presented on a user interface (UI) is the one at which the input is to be represented, at least a portion of the input being provided to a location of the display other than those presenting either of the first text entry area and second text entry area, the UI being presented on the display; and
indicate on the display which of the first text entry area and second text entry area is the one at which the input will be represented.
